(19) United States
(12) Patent Application Publication
(10) Pub. No.: US 2006/0253534 A1
(43) Pub. Date: Nov. 9, 2006

(54) Symmetric networking to support flexible teaching

(76) Inventors: Patrick Michael Milheron, Allen, TX (US); Sekar Udayamurthy, Plano, TX (US); Corey E. Brady, Charlottesville, VA (US); David Michael Cole, Pembroke Pines, FL (US); Sunil Gupta, Weston, FL (US); Tanner Robert Andrews, DeLand, FL (US)

Correspondence Address: TEXAS INSTRUMENTS INCORPORATED, P O BOX 655474, M/S 3999, DALLAS, TX, 75265, US

(21) Appl. No.: 11/124,689

(22) Filed: May 9, 2005

(51) Int. Cl. G06F 15/16

(52) U.S. Cl. 709/205

(57) ABSTRACT

A handheld computing device is utilized to control operations of an analysis system. The analysis system is communicatively coupled to a plurality of handheld computing devices. An authorized user may logon to a handheld computing device and control the operations of the analysis system. Once logged on, the authorized user may perform functions, enter data, or the like on the handheld computing device and transfer the information to the analysis system. In an embodiment, the handheld computing device is a calculator. The personal computer may be coupled to a projector such that a group of students may view the emulator.

### TECHNICAL FIELD

The present invention relates generally to networks, and more particularly, to networks that allow a teacher flexibility to utilize the most appropriate device to perform a specific action.

### BACKGROUND

Teaching complex subjects and concepts, particularly mathematical concepts, typically involves interactively presenting and demonstrating concepts to a group of students. To aid the teacher, analysis systems have been developed to allow a teacher to better illustrate and discuss specific concepts. With respect to mathematical concepts, analysis systems provide teachers with powerful visualization and data analysis tools that allow the teacher to better illustrate the concepts discussed in class.

Analysis systems typically comprise a personal computer having a keyboard, a mouse, a display, and a projector attached thereto. The personal computer is configured to execute an analysis program that provides in-depth analysis tools and includes a graphical display to allow students to visualize the various concepts. A user of the analysis system is typically limited to using the mouse and/or keyboard coupled to the personal computer to input data, commands, functions, or the like.

The mouse and/or keyboard coupled to the personal computer, however, is often not conducive to enter data, commands, functions, and the like. Rather, it would frequently be easier and quicker to enter data via a portable device with focused interfaces and functionality sets. For example, in the context of discussing mathematical concepts it may be easier to enter data on a calculator having a focused interface and functionality set as opposed to using a generic keyboard provided with the personal computer of the analysis system. Unfortunately, current analysis systems do not allow input to be entered on another device.

While some analysis systems are designed to allow the analysis system to be networked to handheld devices such as calculators, these networks only allow the analysis system to distribute data to the connected handheld devices and do not allow two-way communications between the analysis system and the handheld devices. As a result, the teacher is restricted to the input devices of the analysis system, which often may not be the most appropriate input device for the activity being performed.

Therefore, there is a need for an analysis system that allows a teacher to use the most appropriate input device for the activity being performed.

### SUMMARY OF THE INVENTION

These and other problems are generally solved or circumvented, and technical advantages are generally achieved, by preferred embodiments of the present invention which provides a device controller for an emulator of a handheld computing device.

In an embodiment of the present invention, a handheld computing device is provided. The handheld computing device comprises a processor, display, an input device, and an output port. The handheld computing device is configured to perform two-way communications with an analysis system and to allow an authorized user to use the handheld computing device to transfer information to the analysis system.

In another embodiment of the present invention, an analysis system is provided. The analysis system comprises a processor, an input device, a graphics memory, a network interface and memory, wherein the memory is configured to store computer program code to cause the processor to perform two-way communications between the analysis system and a handheld computing device, accept information from the handheld computing device, and perform an analysis program in accordance with the information.

In yet another embodiment of the present invention, a method is provided. The method includes the steps communicatively coupling a plurality of handheld computing devices to an analysis system, logging onto a first handheld computing device of the plurality of handheld computing devices, and controlling the analysis system via the first handheld computing device.

In yet another embodiment of the present invention, a computer program is provided. The computer program includes computer program code for networking the analysis system to a plurality of handheld computing devices, performing two-way communications between the analysis system and the plurality of handheld computing devices, authorizing a user of a first handheld computing device of the plurality of handheld computing devices to control the analysis system from the first handheld computing device, accepting input from either the first handheld computing device or an input device coupled directly to the analysis system, and controlling the analysis system in accordance with the input.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a system diagram in accordance with an embodiment of the present invention;

FIG. 2 illustrates an example of a handheld computing device in accordance with an embodiment of the present invention;

FIG. 3a is a block diagram of a handheld computing device in accordance with an embodiment of the present invention;

FIG. 3b is a block diagram of an analysis system in accordance with an embodiment of the present invention;

FIG. 4 is a data flow diagram illustrating a process of using a handheld computing device to control an analysis system in accordance with an embodiment of the present invention; and

FIG. 5 is a data flow diagram illustrating a process of using a handheld computing device to create an initial state for other handheld computing devices in accordance with an embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

Embodiments of the present invention are discussed below with respect to an embodiment in which a graphing calculator is used as an input device. It should be noted, however, that embodiments of the present invention may be useful for other types of electronic devices, particularly handheld computing devices. Examples of other types of handheld computing devices in which embodiments of the present invention may be useful include scientific calculators, advance calculators able to upload and run software applications, handheld-sized limited-purpose computer devices, handheld-sized educational computer devices, handheld-sized portable computer devices, portable computer devices, personal digital assistants (PDA), palmtop computers, personal communicators, personal intelligent communicators, cellular or mobile telephones, global positioning system (GPS) devices, portable inventory logging computer devices (as may be used by courier deliverers, for example), handheld monitoring devices (as may be used by meter readers, for example), handheld parking ticket administering devices, handheld portable email devices, handheld portable Internet browsing devices, handheld portable gaming devices, and any combination thereof.

Embodiments of the present invention may be particularly useful in a classroom setting wherein a teacher is utilizing an electronic device, such as a personal computer (PC), workstation, specialized devices, or the like, to demonstrate mathematical concepts. For example, a teacher may utilize an analysis program running on a personal computer to demonstrate mathematical concepts which may be solved or analyzed on a calculator, such as a graphing calculator, a scientific calculator, a financial calculator, a programmable calculator, other calculators, or the like. In this embodiment, the analysis system may comprise a personal computer and the handheld computing device may be a calculator.

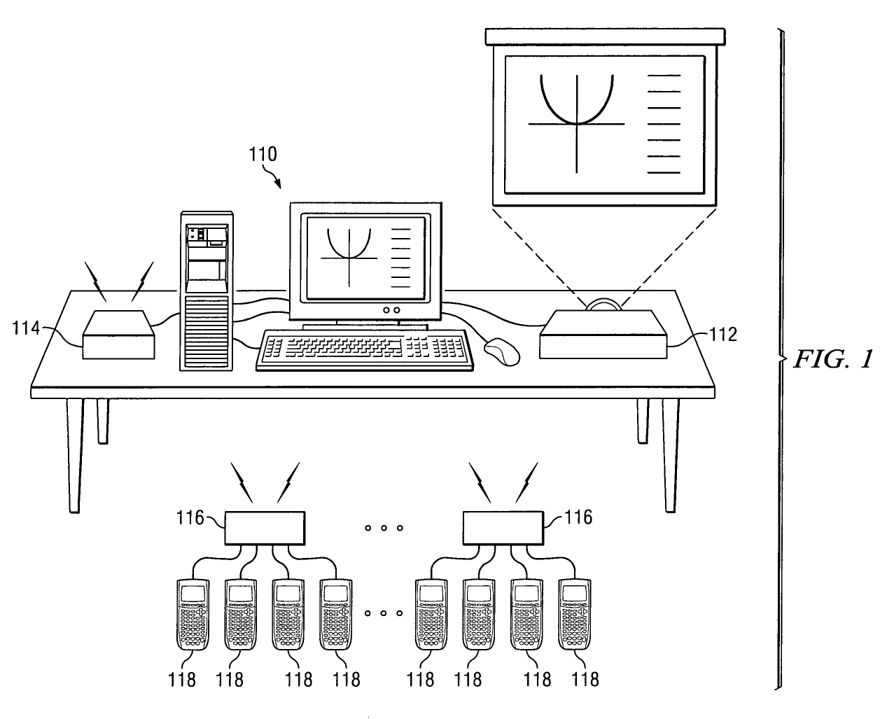

Referring first to FIG. 1, an embodiment of the present invention provides an analysis system 110 communicatively coupled to a projector 112, which may project the display of the analysis system 110 onto a wall, screen, or other surface. The analysis system 110 may comprise, for example, an analysis program (not shown) executing on a general purpose computing device, such as a personal computer, a mini-computer, a main frame, a personal data assistant, a laptop computer, or the like. In another embodiment, the analysis system 110 may comprise a special-purpose system configured to perform the required analysis.

The analysis system 110 is also communicatively coupled to an access point 114. The access point 114 provides an interface for the analysis system 110 to communicate with one or more hubs 116. In a preferred embodiment, the access point 114 provides a wireless interface, such as 802.11b, 802.11g, or the like, to a plurality of hubs 116. The communications link between the access point 114 and the hubs 116, however, may be a wired communications link.

Each of the hubs 116 may be communicatively coupled to one or more handheld computing devices 118. The handheld computing device 118 may be any electronic computing device, such as a calculator, personal data assistant, tablet PC, or the like. For example, in a preferred embodiment the handheld computing device 118 is a graphing calculator such as the TI-84 Plus graphing calculator manufactured by Texas Instruments, Inc., of Dallas, Tex. The TI-84 Plus is a popular graphing calculator used in 6^{th}-12^{th} grades to illustrate various mathematical concepts. In another embodiment, the handheld computing device 110 is an electronic device operating an emulation of another electronic device. For example, the handheld computing device 118 may be a PDA configured to perform an emulation of the TI-84 Plus graphing calculator. As another example, the handheld computing device 118 may simply be a specialized input device that allows easier input and control of the analysis system 110. Other types of devices may be used.

The communications links between the handheld computing devices 110 and the hubs 116 and between the analysis system 110 and the access point 114 are illustrated as a wired interface for illustrative purposes only. In an embodiment, the wired interfaces comprise a USB communications link. These wired communications links, however, may comprise either a wired or wireless communications link. Once connected, bi-directional communications may be performed between the handheld computing devices 118 and the analysis system 110 and/or other handheld computing devices 118 via the hubs 116 and the access point 114.

Furthermore, it should be noted that the analysis system 110, the access point 114, the hub 116, and the handheld computing devices 118 are illustrated as separate components for illustrative purposes only. Two or more of these components may be integrated into a single component. For example, the access point 114 may be integrated into the analysis system 110, and a wireless transceiver may be integrated into the handheld computing device 118 to communicate directly with the access point 114 and/or the analysis system 110, thereby negating a need for separate hubs 116.

In operation, as illustrated in FIG. 1, a user (e.g., a teacher) initiates the analysis system 110 during classroom lectures to discuss and illustrate concepts covered in class. The user may control the operation of the analysis system 110 via an input device (e.g., a keyboard, mouse, etc.) coupled directly to the analysis system 110 in order to illustrate a function of the calculator and/or to illustrate a mathematical concept. As the user controls the analysis system 110, results, such as graphs, plots, equations, text, symbols, or the like, are enlarged and displayed on a large surface, such as a screen or wall, via the projector 112.

Furthermore, in accordance with teachings of the present invention, the user may utilize one or more of the handheld computing devices 118 to control the analysis system 110. In this manner, the user may utilize the device most appropriate to control the analysis system to perform specific functions. It should be appreciated that this provides the user greater control and flexibility, as well as greater mobility.

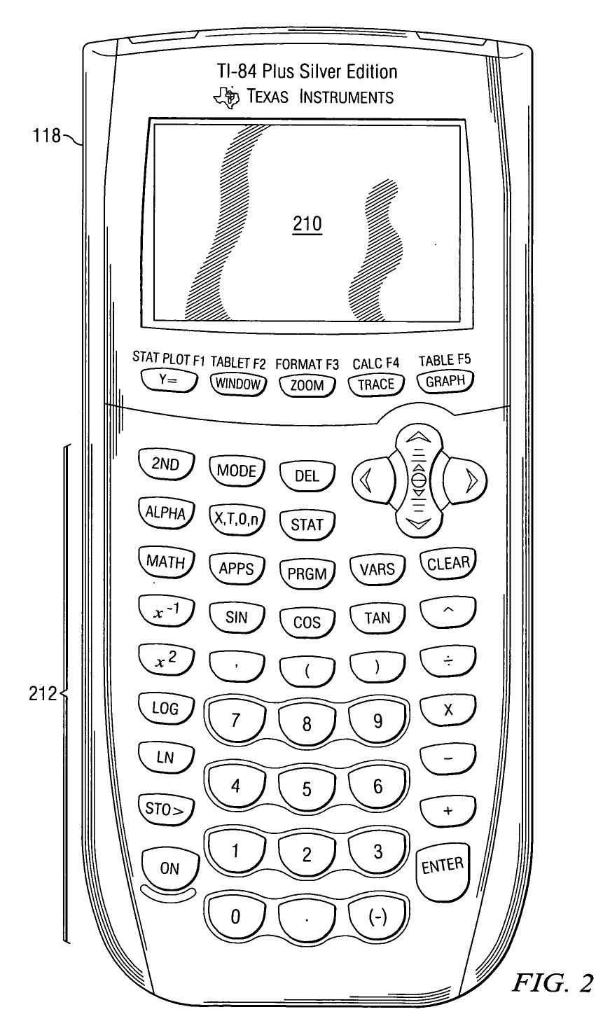

Referring now to FIG. 2, an example of a handheld computing device 118 in accordance with an embodiment of the present invention is shown. For illustrative purposes only, the handheld computing device 118 illustrated in FIG. 2 is similar to a TI-84 Plus graphing calculator. It should be noted that the TI-84 Plus is used for illustrative purposes only and does not limit the invention as claimed.

As shown in FIG. 2, the handheld computing device 118 preferably includes a graphical display 210 and a set of keys 212. The graphical display 210 provides a means upon which graphs of various functions and/or one or more lines of text/symbols may be displayed. The graphical display 210 may be, for example, an LED display. The set of keys 212 is located below the graphical display 210 and provides a method for a user, e.g., a student, to enter data and functions. Other configurations and functions may be used.

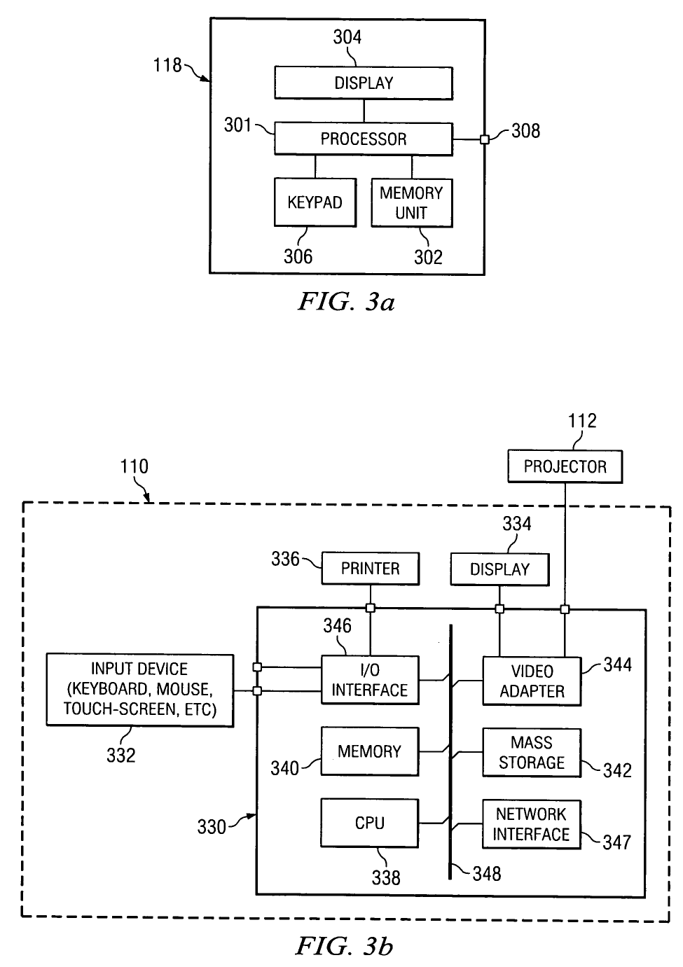

FIGS. 3a and 3b are block diagrams of the handheld computing device 118 and the analysis system 110, respectively, in accordance with an embodiment of the present invention. Generally, the handheld computing device 118 includes a processor 301 connected to a memory unit 302, which may include one or both of read-only memory (ROM) and random-access memory (RAM). In a preferred embodiment, however, the handheld computing device 118 includes ROM to store software programs and RAM to store intermediate data and operating results.

An input/output port 308 provides connectivity to hubs 116 (FIG. 1), thereby communicatively coupling the handheld computing device 118 to the analysis system 110. In a preferred embodiment, the input/output port 308 comprises a bi-directional connection such as a mini-A USB port. In this manner, the handheld computing device 118 may transmit information to the analysis system 110 as well as receive information from the analysis system 110. Also included in the handheld computing device 118 are a display 304 and a keypad 306.

The analysis system 110 may comprise a processing unit 330 equipped with one or more input devices 332 (e.g., a mouse, a keyboard, or the like), and one or more output devices, such as a display 334, a printer 336, or the like. The processing unit 330 may be, for example, a desktop computer, a workstation, a laptop computer, a personal digital assistant, a dedicated unit customized for a particular application, or the like.

Preferably, the processing unit 330 includes a central processing unit (CPU) 338, memory 340, a mass storage device 342, a video adapter 344, and an I/O interface 346 connected to a bus 348. The bus 348 may be one or more of any type of several bus architectures including a memory bus or memory controller, a peripheral bus, video bus, or the like. The CPU 338 may comprise any type of electronic data processor. For example, the CPU 338 may comprise a Pentium™ processor from Intel Corp., an Athlon processor from Advanced Micro Devices, Inc., a Reduced Instruction Set Computer (RISC), Application-Specific Integrated Circuit (ASIC), or the like. The memory 340 may comprise any type of system memory such as static random access memory (SRAM), dynamic random access memory (DRAM), synchronous DRAM (SDRAM), read-only memory (ROM), a combination thereof, or the like. In an embodiment, the memory 340 may include ROM for use at boot-up, and DRAM for data storage for use while executing programs.

The mass storage device 342 may comprise any type of storage device configured to store data, programs, and other information and to make the data, programs, and other information accessible via the bus 348. In a preferred embodiment, the mass storage device 342 is configured to store the emulation program to be executed by the CPU 338. The mass storage device 342 may comprise, for example, one or more of a hard disk drive, a magnetic disk drive, an optical disk drive, or the like.

The video adapter 344 and the I/O interface 346 provide interfaces to couple external input and output devices to the processing unit 330. As illustrated in FIG. 3b, examples of input and output devices include the display 334 coupled to the video adapter 344 and the mouse/keyboard 332 and the printer 336 coupled to the I/O interface 346. Other devices may be coupled to the processing unit 330.

The processing unit 330 also includes a network interface 347. The network interface allows the processing unit 330 to communicate with remote units via a network (not shown). In a preferred embodiment in which the present invention is utilized in a classroom setting to illustrate mathematical concepts, the network interface 347 allows the analysis system 110 to network to handheld computing devices 118, e.g., calculators. The network interface 347 may provide an interface for a wired link, such as an Ethernet cable or the like, or a wireless link.

One type of networking system that may be used with the present invention to communicatively couple the handheld computing devices 118 to the analysis system 110 is the TI-Navigator™ by Texas Instruments, Dallas, Tex. The TI-Navigator™ includes hubs that couple to calculators and wirelessly communicate with an access point that is coupled to a personal computer that is configured to act as an analysis system.

It should be noted that the analysis system 110 may include other components. For example, the analysis system 110 may include power supplies, cables, a motherboard, removable storage media, cases, and the like. These other components, although not shown, are considered part of the analysis system 110.

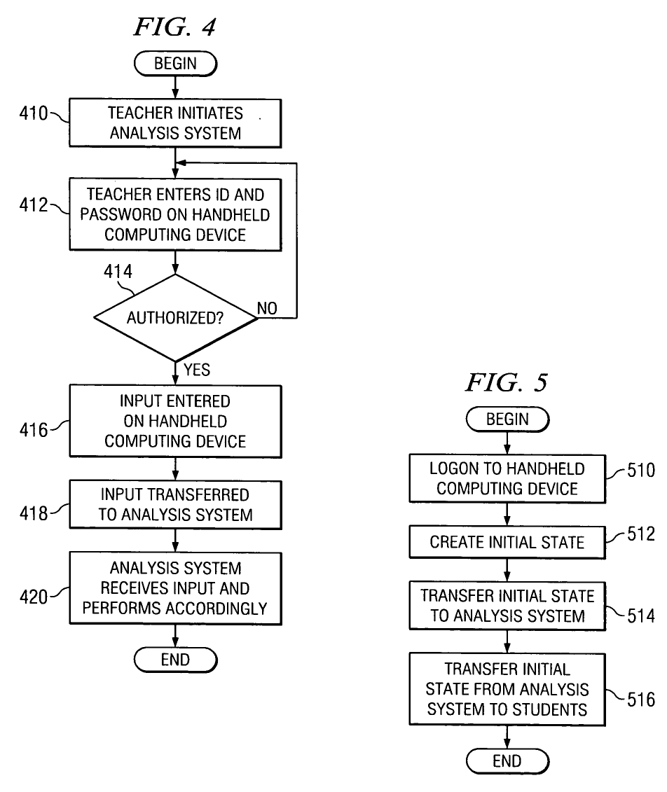

FIG. 4 is a data flow diagram illustrating the use of alternate input devices in accordance with an embodiment of the present invention. The process begins in step 410, wherein the analysis system 110 (FIG. 1) is initiated. At this point the analysis system 110 is executing and, preferably, displaying results on a screen such that a group of students may view the results. The user (e.g., the teacher) may control the analysis system 110 via an input device 332 (FIG. 3) such as a mouse, keyboard, or the like.

As discussed above, however, many times it is preferred to use a different input device other than an input device coupled directly to the analysis system 110. For example, in the situation in which mathematical concepts are being taught using a calculator, it may be significantly easier for a user to enter data using a calculator that is specifically designed to perform certain functions. Accordingly, in steps 412-416, the user is allowed to enter data on a handheld computing device (e.g., a calculator).

In a preferred embodiment, only authorized individuals are allowed to control the analysis system 110 via a handheld computing device 118, particularly in the situation as described above with reference to FIG. 1 wherein a group of students may be communicatively coupled to the analysis system. One manner in which access may be controlled is to assign authorized individuals, such as the teacher, a teacher's aid, or the like, a user identifier and/or a password. Then, as illustrated in step 412, the user gains access to the analysis system from a handheld computing device by entering the assigned user identifier and/or password. The user identifier and/or password may be sent to the analysis system for authorization, and if authorized, the analysis system may transmit to the handheld computing device an authorization indication. In another embodiment, the handheld computing device may transmit data to the analysis system with or without receiving an authorization indication. In this embodiment, it is preferred that the analysis system discard or otherwise ignore information from unauthorized users.

Thereafter, in step 414, a determination is made whether or not the user is authorized to control the analysis system from a handheld computing device. If a determination is made that the user identifier (and password) is not authorized, then access to control the analysis system 110 is blocked and processing returns to step 412.

If, on the other hand, a determination is made that the user identifier (and password) is authorized, then processing proceeds to step 416, wherein the user is allowed to enter input on the handheld computing device 118. It should be noted that it is preferred that the user may utilize any connected handheld computing device 118 to enter input. Specifically, the ability to enter data on a remote device is user-centric, as opposed to device-centric.

For example, in the situation discussed above wherein an embodiment of the present invention is being utilized in a classroom environment, the analysis system 110 may be used to teach mathematical concepts and the handheld computing device 118 may be a calculator. Each student may have a calculator communicatively coupled to the analysis system 110 to send and receive data. The students, however, may not have the ability to control the analysis system 110. The teacher may use a student's calculator or the teacher's own calculator, enter the assigned user identifier and password, and then utilize the calculator as an input device 332 to control the analysis system 110.

The teacher may also utilize this feature to perform other functions of which it is desirable to restrict the use. For example, the user may use this feature to transfer settings, data, or the like from a student's calculator to the analysis system 110. The teacher may then transfer the data from the analysis system to the rest of the class. One example of this feature is described in greater detail below with reference to FIG. 5.

In step 418, the input entered by the user is transferred to the analysis system 110 via the hub 116 and access point 114. Thereafter, the analysis system 110 receives the input and performs accordingly in step 420.

FIG. 5 is a data flow diagram illustrating a use of an embodiment of the present invention. The process begins in step 510, wherein a user logs onto a handheld computing device 118 as described above. Once logged on, the user may create an initial state that the user would like to distribute to one or more other users as illustrated in step 512. The initial state may be, for example, a list of data, collected data, a graph, a plot, an equation, or the like.

Once created, processing proceeds to step 514, wherein the initial state is transferred to the analysis system 110. Thereafter, in step 516 the user may use the analysis system 110 to distribute the initial state to the other users.

In a classroom environment, this example may be particularly beneficial by allowing teachers to utilize a calculator to create an initial state that may be used to illustrate a particular concept. The state may be created during class or prior to class. During class, the students may connect to the analysis system 110 and receive the initial state created by the teacher.

A teacher may also use embodiments of the present invention to determine the class' understanding of a specific concept. For example, a teacher may pose a question concerning a mathematical concept. The teacher may present the class a “YES/NO” question or a multiple-choice question to the class. Students may individually enter their answer on their calculator, which transfers the answers to the analysis system. The analysis system may compile the answers and present the teacher with the results of the poll, thereby giving the teacher an insight as to the student's level of understanding.

It should also be noted that all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise. In other embodiments, a hardware system may be specifically designed to perform one or more of the functions described herein.

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A calculator comprising:
a processor configured for performing mathematical operations;
a display communicatively coupled to the processor;
an input device communicatively coupled to the processor; and
an output port configured to communicatively couple the calculator to an analysis system, wherein the calculator is configured to perform two-way communications with the analysis system and allow an authorized user to use the calculator to transfer information to the analysis system.

2. The calculator of claim 1, wherein the calculator is further configured to allow an authorized user to control the analysis system with the calculator.

3. The calculator of claim 1, wherein the output port comprises a USB port.

4. The calculator of claim 1, wherein the analysis system comprises a personal computer.

5. The calculator of claim 1, wherein the calculator comprises an electronic device configured to emulate a calculator.

6. The calculator of claim 1, wherein the authorized user is determined via a user logon screen.

7. The calculator of claim 6, wherein the user logon screen requests a user name and password.

8. A method comprising:
communicatively coupling a plurality of calculators to an analysis system;
logging onto a first calculator of the plurality of calculators; and
controlling the analysis system via the first calculator.

9. The method of claim 8, wherein the analysis system comprises a personal computer.

10. The method of claim 8, wherein the first calculator comprises an electronic device configured to emulate a calculator.

11. The method of claim 8, wherein the logging onto a first calculator includes:
requesting a user logon screen; and
entering an authorized user identifier on the user logon screen.

12. The method of claim 11, wherein the authorized user identifier includes an account name and a password.

13. A method of instruction of students in a classroom, the method comprising:
displaying an output of an analysis system to a plurality of students;
communicatively coupling a plurality of calculators to the analysis system;
allowing a user to logon to the analysis system via a first calculator of the plurality of calculators;
receiving input entered by the user on the first calculator;
transmitting information related to the input from the first calculator to the analysis system; and
causing the analysis system to act according to the information.

14. The method of claim 13, wherein the first calculator comprises an electronic device configured to emulate the first calculator.

15. The method of claim 13, wherein the first calculator is a graphing calculator.

16. The method of claim 13, wherein the students are in grade level from sixth grade to twelfth grade.

17. The method of claim 13, wherein the information includes at least one of data, commands, results, and a combination thereof.

18. The method of claim 13, wherein the allowing a user to logon includes:
presenting by the first calculator a user logon screen;
receiving by the first calculator a user identifier entered on the user logon screen;
determining whether the user identifier is an authorized user identifier; and
allowing the user to cause the first calculator to transmit information to the analysis system.

19. The method of claim 18, wherein the authorized user identifier includes an account name and a password.

20. The method of claim 18, wherein the determining is performed at least in part by transmitting the user identifier from the first calculator to the analysis system and receiving from the analysis system by the first calculator an authorization indicator.
